(19) United States
(12) Patent Application Publication
(10) Pub. No.: US 2013/0054196 A1
(43) Pub. Date: Feb. 28, 2013

(54) MOTION SENSING APPARATUS AND METHOD THEREOF

(71) Applicants: Kyung Rin Kim, Gyeonggi-do (KR); Byoung Won Hwang, Gyeonggi-do (KR); Chang Hyun Kim, Gyeonggi-do (KR)

(72) Inventors: Kyung Rin Kim, Gyeonggi-do (KR); Byoung Won Hwang, Gyeonggi-do (KR); Chang Hyun Kim, Gyeonggi-do (KR)

(21) Appl. No.: 13/569,097

(22) Filed: Aug. 7, 2012

(30) Foreign Application Priority Data
Aug. 26, 2011 (KR) 10-2011-0085756

(51) Int. Cl. G06F 15/00

(52) U.S. Cl. 702/189

(57) ABSTRACT

The present disclosure provides a motion sensing apparatus comprising a sensor configured to sense a motion of an object; a variation determination unit configured to determine a variation in the sensed signal provided from the sensor; an ODR control unit configured to control an output data rate (ODR) in proportion to a determination result at the variation determination unit; and a digital signal output unit configured to read the signal provided from the sensor based on the ODR controlled by the ODR control unit, and output the same as a digital value.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0085756, entitled filed Aug. 26, 2011, which is hereby incorporated by reference in its entirety into this application.

### BACKGROUND OF THE INVENTION

1. Field of the Invention

The present disclosure relates to a motion sensing apparatus and a method thereof, and more particularly, relates to a motion sensing apparatus which adjusts an output data rate (ODR) based on a variation in a sensed signal, and a method used therefor.

2. Description of the Related Art

Recently, various types of sensors have been developed which may electrically or magnetically sense a motion of human being or object, and output the sensed signal as an analog or digital form.

These sensors may include an acceleration sensor, an angular velocity sensor, a gyro-sensor, a geomagnetic sensor, an optical sensor or the like, which employ various ways and principles.

The acceleration sensor, the angular velocity sensor, the gyro-sensor or the like serve to measure an inertial/physical force. As such, they are called as an inertial sensor. Recently, an approach in which both of the acceleration sensor and the angular velocity sensor are employed is under development to be designed for various applications.

Outputs provided from the sensors are converted into analog or digital values so that they can be applied to various applications.

In general, signals provided from a sensor are inputted to an analog circuit wherein they are converted into analog one. Thereafter, the analog signals are converted into digital one at an analog-to-digital circuit (ADC). The converted values (or digital data) are outputted at an output data rate (ODR) suitable for a given application.

For example, a conventional motion sensing apparatus disclosed in Korean Patent Laid-Open Publication No. 2009-0009007 is designed to output data at a predetermined fixed ODR irrespective of a variation of signals actually obtained at a sensor.

In such conventional motion sensing apparatus, when a motion of object to be sensed by the sensor is quickly deployed compared to usual, the signal provided from the sensor may be substantially suddenly varied.

Meanwhile, when a motion of object to be sensed by the sensor is slowly deployed compared to usual, the signal provided from the sensor may be substantially slowly varied.

Even in such case, the conventional motion sensing apparatus outputs data at a predetermined fixed ODR, which may cause the following problems.

First, when a motion of object to be sensed is quickly deployed compared to usual, i.e., when the signal obtained at the sensor is substantially suddenly varied, the application of a relatively small ODR to the output data may cause that a variation in the signal is sufficiently not reflected in the output data. This causes degradation in motion sensitivity.

Meanwhile, when a motion of object to be sensed is substantially slow compared to usual, i.e., when the signal obtained at the sensor is substantially slowly varied, the application of a relatively large ODR to the output data may cause unnecessary output of a substantial amount of data in spite of a slow variation in the signal. This causes unnecessary consumption of electric power and system resources (e.g., a central processing unit: CPU).

### SUMMARY OF THE INVENTION

The present invention has been invented in order to overcome the above-described problems and it is, therefore, an object of the present invention to provide a motion sensing apparatus which adjusts an output data rate (ODR) based on a variation in signal to be sensed.

Further, it is another object of the present invention to provide a motion sensing method which adjusts an output data rate (ODR) based on a variation in signal to be sensed.

In accordance with one aspect of the present invention to achieve the object, there is provided a motion sensing apparatus comprising: a sensor configured to sense a motion of an object; a variation determination unit configured to determine a variation in the sensed signal provided from the sensor; an ODR control unit configured to control an output data rate (ODR) in proportion to a determination result at the variation determination unit; and a digital signal output unit configured to read the signal provided from the sensor based on the ODR controlled by the ODR control unit, and output the same as a digital value.

The variation determination unit may include a difference value calculation unit configured to calculate a difference value Diff between the signals provided from the sensor, and an accumulated mean value calculation unit configured to calculate an accumulated mean value of the difference values calculated at the difference value calculation unit.

In accordance with another aspect of the present invention to achieve the object, there is provided a motion sensing method comprising: sensing a motion of an object and outputting the sensed signal; determining a variation in the sensed signal obtained at the sensing; adjusting an output data rate (ODR) in proportion to a determination result at the determining; and reading the signal provided from the sensor based on the ODR adjusted at the adjusting, and outputting the same as a digital value.

The determining may include calculating a difference value Diff between the signals obtained at the sensing, and computing an accumulated mean value of the difference values calculated at the calculating.

The calculating may include calculating an (n+1)th difference value Diffₙ₊₁ by using the following equation,

Diffₙ₊₁=dₙ₊₁−dₙ

where, n is a nonnegative integer including zero.

The computing may include calculating the difference value Diff calculated at the difference value calculation unit by using the following equation:

$$( {\sum }_{n = 0}^{N - 1} {Diff}_{n + 1} ) / N$$

where, N is a predetermined nonnegative integer including zero.

The sensing may further include performing amplification and/or noise reduction on the sensed signal.

The sensing may further include converting the sensed signal into a digital signal.

The sensing may further include, after performing amplification and/or noise reduction on the sensed signal, converting the amplified or noise-reduced signal into a digital signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph showing a general relation between a sensor output signal and an output data rate.

FIG. 2 is a schematic block diagram of a motion sensing apparatus in accordance with one embodiment of the present disclosure.

FIG. 3 is an exemplary schematic block diagram of a variation determination unit in accordance with one embodiment of the present disclosure.

FIG. 4 is a schematic block diagram of a motion sensing apparatus in accordance with another embodiment of the present disclosure.

FIG. 5 is a graph utilized to facilitate understanding of a principle employed in the variation determination unit in accordance with one embodiment of the present disclosure.

FIG. 6 is a graph showing a relation between a sensor output signal and an output data rate in accordance with another embodiment of the present disclosure.

FIG. 7 is a schematic flowchart showing a motion sensing method in accordance with one embodiment of the present disclosure.

FIG. 8 is a schematic flowchart showing a variation determination procedure in accordance with one embodiment of the present disclosure.

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be varied according to users or operator's intentions or customs. Thus, the terms shall be defined based on the contents described throughout the specification.

The technical sprit of the present invention should be defined by the appended claims, and the following embodiments are merely examples for efficiently describing the technical spirit of the present invention to those skilled in the art.

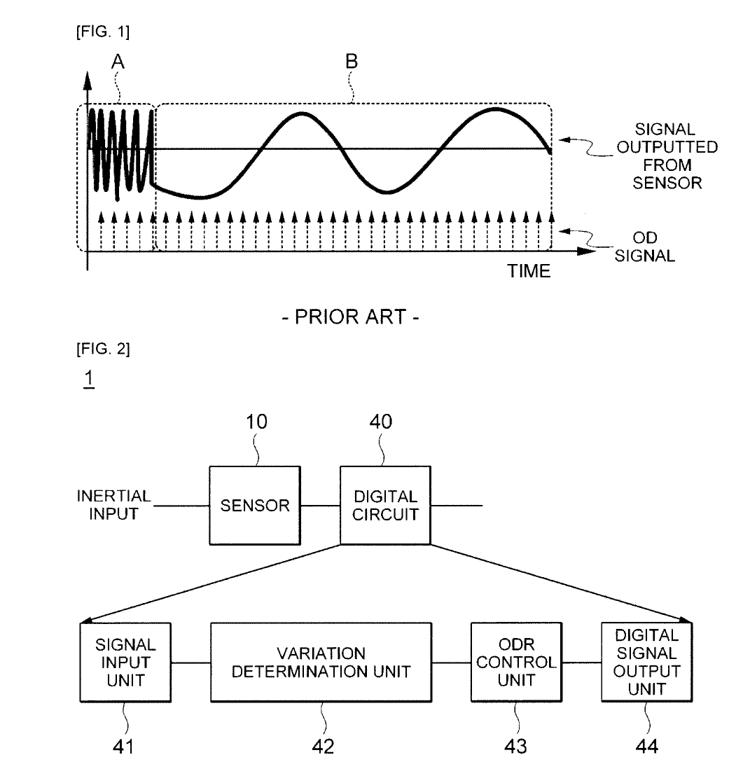

FIG. 1 is a graph showing a general relation between a sensor output signal and an output data rate.

In FIG. 1, A represents a region in which, when a signal obtained at the sensor is substantially suddenly varied, i.e., when a motion of object to be sensed is quickly deployed compared to usual, while B represents a region in which, when a signal obtained at the sensor is substantially slowly varied, i.e., when a motion of object to be sensed is slowly deployed compared to usual.

In one embodiment, the same ODR is applied to both the A and B regions.

In this case, if it is assumed that the ODR shown in FIG. 1 is adapted for the A region, a necessary consumption of resources and electric power is determined to be caused at the region B.

Meanwhile, if it is assumed that the ODR shown in FIG. 1 is adapted for the B region, most of signals provided from the sensor are deemed to be not outputted as digital one at the A region. This prevents a motion of object to be sensed from finely being detected.

FIG. 2 is a schematic block diagram of a motion sensing apparatus 1 in accordance with one embodiment of the present disclosure.

As shown in FIG. 2, a motion sensing apparatus 1 according to one embodiment of the present disclosure includes a sensor 10 and a digital circuit 40.

The sensor 10 is configured to electrically or magnetically sense a motion of an object and output a signal corresponding to the sensed motion as an analog or digital form. The sensor 10 may include, for example, an acceleration sensor, an angular velocity sensor, a gyro-sensor, a geomagnetic sensor, an optical sensor, or the like.

The digital circuit 40, which is configured to convert and output the signal provided from the sensor 10, includes a signal input unit 41, a variation determination unit 42, an ODR control unit 43, and a digital signal output unit 44.

The signal input unit 41 receives the signal provided from the sensor 10.

The variation determination unit 42 is configured to determine a variation in the signal provided from the sensor 10. Specifically, the variation determination unit 42 determines whether the signal provided from the sensor 10 is suddenly or slowly varied.

The ODR control unit 43 is configured to control the output data rate (ODR) in proportion to a determination result at the variation determination unit 42. Specifically, the ODR control unit 43 increases the ODR when the signal provided from the sensor 10 is suddenly varied, and decreases the ODR when the signal is slowly varied.

The digital signal output unit 44 is configured to read the signal provided from the sensor 10 based on the ODR controlled by the ODR control unit 43, and then output the same as a digital value.

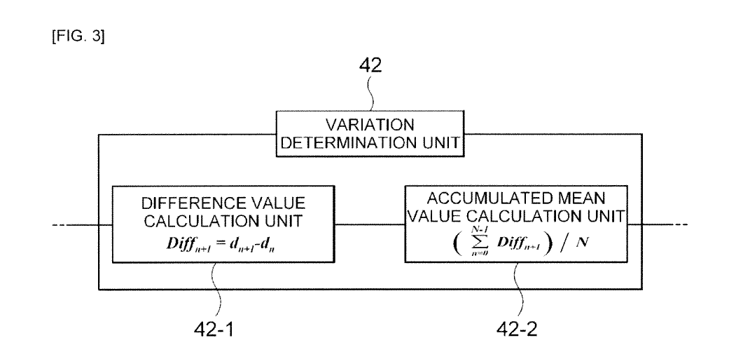

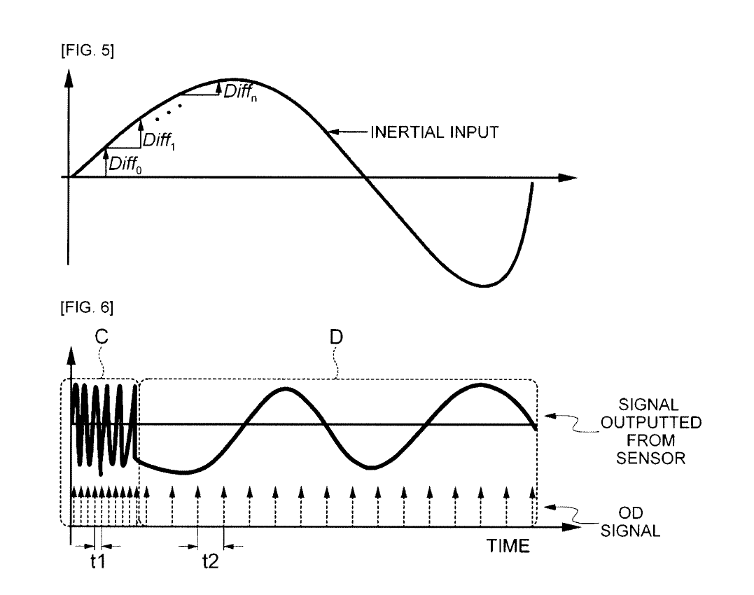

FIG. 3 is an exemplary schematic block diagram of the variation determination unit 42 in accordance with one embodiment of the present disclosure. FIG. 5 is a graph utilized to facilitate understanding of a principle employed in the variation determination unit 42 in accordance with one embodiment of the present disclosure.

As shown in FIGS. 3 and 5, the variation determination unit 42 includes a difference value calculation unit 42-1 and an accumulated mean value calculation unit 42-2.

The difference value calculation unit 42-1 is configured to calculate a difference value Diff between the signals provided from the sensor 10. The accumulated mean value calculation unit 42-2 is configured to calculate an accumulated mean value of the difference values calculated at the difference value calculation unit 42-1.

The difference value calculation unit 42-1 calculates an (n+1)th difference value, i.e., Diffₙ₊₁ by using the following equation so that it can calculate the difference values provided from the sensor 10.

Diffₙ₊₁=dₙ₊₁−dₙ [Equation 1]

where, n is a nonnegative integer including zero.

The accumulated mean value calculation unit 42-2 calculates the difference value Diff calculated at the difference value calculation unit 42-1 by using the following equation.

$$( {\sum }_{n = 0}^{N - 1} {Diff}_{n + 1} ) / N \qquad [ Equation 1 ]$$

where, N is a predetermined nonnegative integer including zero.

As an example, if it is assumed that the valuable n is incremented by one on a unit of 0.1 second, the difference value calculation unit 42-1 divides the signal values provided from the sensor 10 during one second into ten equal parts, and calculates the difference value Diff at respective intervals. The accumulated mean value calculation unit 42-2 calculates a mean value of ten difference values.

With this configuration, when the mean value is greater than a predetermined reference value, the ODR is increased. Meanwhile, when the mean value is smaller than the predetermined reference value, the ODR is decreased. This enables digital data having a value obtained by finely reflecting a motion of object to be sensed to be outputted. Further, this minimizes an unnecessary consumption of electric power, which in turn, prevents an unnecessary overload from being caused at a system resource such as a central processing unit. Thus, it is possible to enhance the efficient operation of the system resource.

In one embodiment, the valuable N may be determined as other values depending on an accuracy of operation of the variation determination unit 42. Specifically, obtaining a high level of operation accuracy requires that the valuable N is set to be a relatively large value at a constant period of time. Conversely, if the valuable N is set to be a relatively small value at the same period of time, the accuracy of the variation determination unit 42 may be degraded.

For example, as described above, when one second is set to be divided into ten equal parts, the valuable N is set to 10. This allows that the difference value calculation unit 42-1 to perform a calculation for the difference value Diff on the basis of 0.1 second. Meanwhile, when the valuable N is set to 100, the difference value calculation unit 42-1 calculates the difference value Diff on the basis of 0.01 second.

Therefore, a fine control of the ODR requires the valuable N of a relatively large value, while a rough control of the ODR requires the valuable N of a relatively small value. Thus, it is possible to make an optimal motion sensing.

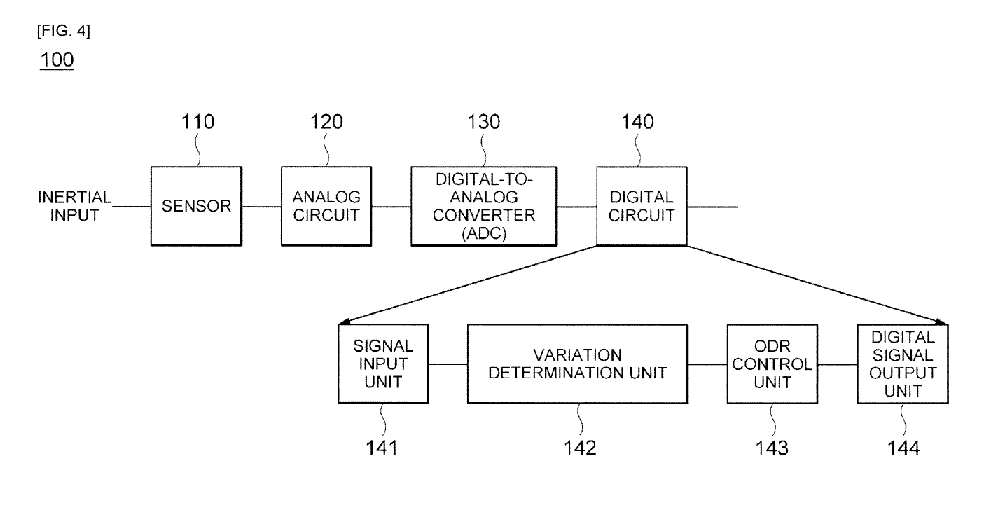

FIG. 4 is a schematic block diagram of a motion sensing apparatus in accordance with another embodiment of the present disclosure.

As shown in FIG. 4, a motion sensing apparatus 100 according to an embodiment of the present disclosure further includes a sensor 110, a digital circuit 140, and an analog circuit 120 and a digital-to-analog converter (ADC) 130, which are disposed therebetween.

The analog circuit 120, which is connected to an output terminal of the sensor 110, is configured to perform amplification and/or noise reduction on a signal outputted from the sensor 110.

The ADC 130, which is connected to an output terminal of the analog circuit 120, is configured to convert a signal of analog form provided from the analog circuit 120 into one of digital form.

The digital circuit 140 includes a signal input unit 141, a variation determination unit 142, an ODR control unit 143 and a digital signal output unit 144.

The variation determination unit 142 is configured to determine a variation in the digital signal provided from the ADC 130. The digital signal output unit 144 is configured to read the signal provided from the ADC 130 and convert the same into a digital signal.

FIG. 6 is a graph showing a relation between a sensor output signal and an output data rate in accordance with one embodiment of the present disclosure.

As shown in FIG. 6, it was found that a region C has a relatively large value compared to a region D for a variation in signal provided from the sensor. As such, the ODR in the region C is set to be higher than one of the region D, i.e., t1<t2, so that it is possible to achieve an optimal motion sensing.

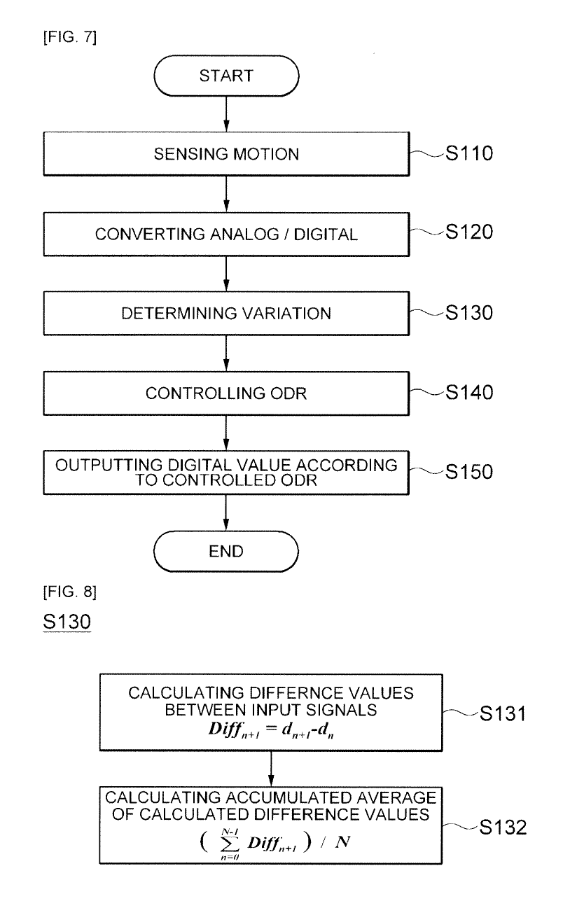

FIG. 7 is a schematic flowchart showing a motion sensing method in accordance with another embodiment of the present disclosure. FIG. 8 is a schematic flowchart showing a variation determination procedure in accordance with another embodiment of the present disclosure.

As shown in FIG. 7, the motion sensing method according to an embodiment of the present disclosure includes sensing a motion of an object and generating an analog signal corresponding thereto (S110).

Subsequently, the method includes converting the analog signal provided from the sensor into a digital signal (S120). In other embodiment, the method may include amplifying the analog signal provided from the sensor or removing noises contained therein, prior to the conversion process.

Subsequently, the method includes determining a variation in the digital signal (S130). The determining process may be performed at the variation determination units 42 and 142, which have been explained above. The operating principle of the variation determination is similar to one as described above, so a description thereof will be omitted to avoid duplication.

Thereafter, the method includes adjusting the ODR in proportion to the determined variation (S140).

Subsequently, the method includes reading the signal provided from a series of the sensor, the analog circuit and the ADC, based on the ODR adjusted at the step S140 (S150). The signal generated through this process may be used to various applications.

According to the present disclosure in some embodiments, it is possible to change an output data rate (ODR) responsive to a variation in a signal provided from a sensor, to thereby output a digital data to which a motion of an object to be sensed is faithfully reflected. Further, it is possible to minimize an unnecessary consumption of electric power, thereby preventing a system resource such as a central processing unit from being undergone an unnecessary overload. Therefore, this provides the efficient operation of the system resource.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

What is claimed is:

1. A motion sensing apparatus comprising:
a sensor configured to sense a motion of an object;
a variation determination unit configured to determine a variation in the sensed signal provided from the sensor;
an ODR control unit configured to control an output data rate (ODR) in proportion to a determination result at the variation determination unit; and
a digital signal output unit configured to read the signal provided from the sensor based on the ODR controlled by the ODR control unit, and output the same as a digital value.

2. The motion sensing apparatus according to claim 1, wherein the variation determination unit includes:
a difference value calculation unit configured to calculate a difference value Diff between the signals provided from the sensor; and
an accumulated mean value calculation unit configured to calculate an accumulated mean value of the difference values calculated at the difference value calculation unit.

3. The motion sensing apparatus according to claim 2, wherein the difference value calculation unit calculates an (n+1)th difference value Diffₙ₊₁ by using the following equation,
Diffₙ₊₁=dₙ₊₁−dₙ
Where, n is a nonnegative integer including zero.

4. The motion sensing apparatus according to claim 3, wherein the accumulated mean value calculation unit calculates the difference value Diff calculated at the difference value calculation unit by using the following equation:
$$( {\sum }_{n = 0}^{N - 1} {Diff}_{n + 1} ) / N$$
where, N is a predetermined nonnegative integer including zero.

5. A motion sensing apparatus comprising:
a sensor configured to sense a motion of an object;
an analog circuit connected to an output terminal of the sensor, the analog circuit being configured to perform amplification and/or noise reduction on the sensed signal provided from the sensor;
an analog-to-digital converter (ADC) connected to an output terminal of the analog circuit, the ADC being configured to convert a signal of analog form provided from the analog circuit into one of digital form;
a variation determination unit configured to determine a variation in the digital signal provided from the ADC;
an output data rate control unit configured to control an output data rate (ODR) in proportion to a determination result at the variation determination unit; and
a digital signal output unit is configured to read the signal provided from the ADC and convert the same into a digital signal.

6. The motion sensing apparatus according to claim 5, wherein the variation determination unit includes:
a difference value calculation unit configured to calculate a difference value Diff between the signals provided from the ADC; and
an accumulated mean value calculation unit configured to calculate an accumulated mean value of the difference values calculated at the difference value calculation unit.

7. The motion sensing apparatus according to claim 6, wherein the difference value calculation unit calculates an (n+1)th difference value Diffₙ₊₁ by using the following equation,
Diffₙ₊₁=dₙ₊₁−dₙ
where, n is a nonnegative integer including zero.

8. The motion sensing apparatus according to claim 7, wherein the accumulated mean value calculation unit calculates the difference value Diff calculated at the difference value calculation unit by using the following equation:
$$( {\sum }_{n = 0}^{N - 1} {Diff}_{n + 1} ) / N$$
where, N is a predetermined nonnegative integer including zero.

9. A motion sensing method comprising:
sensing a motion of an object and outputting the sensed signal;
determining a variation in the sensed signal obtained at the sensing;
adjusting an output data rate (ODR) in proportion to a determination result at the determining; and
reading the signal provided from the sensor based on the ODR adjusted at the adjusting, and outputting the same as a digital value.

10. The motion sensing method according to claim 9, wherein the determining includes:
calculating a difference value Diff between the signals obtained at the sensing; and
computing an accumulated mean value of the difference values calculated at the calculating.

11. The motion sensing method according to claim 10, wherein the calculating includes calculating an (n+1)th difference value Diffₙ₊₁ by using the following equation,
Diffₙ₊₁=dₙ₊₁−dₙ
where, n is a nonnegative integer including zero.

12. The motion sensing method according to claim 11, wherein the computing includes calculating the difference value Diff calculated at the difference value calculation unit by using the following equation:
$$( {\sum }_{n = 0}^{N - 1} {Diff}_{n + 1} ) / N$$
where, N is a predetermined nonnegative integer including zero.

13. The motion sensing method according to claim 9, wherein the sensing further includes performing amplification and/or noise reduction on the sensed signal.

14. The motion sensing method according to claim 9, wherein the sensing further includes converting the sensed signal into a digital signal.

15. The motion sensing method according to claim 9, wherein the sensing further includes, after performing amplification and/or noise reduction on the sensed signal, converting the amplified or noise-reduced signal into a digital signal.
